(19) United States
(12) Patent Application Publication
(10) Pub. No.: US 2017/0145611 A1
(43) Pub. Date: May 25, 2017

(54) CLUTCH DEVICE FOR WASHING MACHINE AND WASHING MACHINE

(71) Applicant: NIDEC SANKYO CORPORATION, Suwa-gun, Nagano (JP)

(72) Inventors: Takehiko Yazawa, Suwa-gun, Nagano (JP); Akihiro ITO, Suwa-gun, Nagano (JP)

(73) Assignee: NIDEC SANKYO CORPORATION, Suwa-gun, Nagano (JP)

(21) Appl. No.: 15/323,166

(22) PCT Filed: Jun. 26, 2015
(86) PCT No.: PCT/JP2015/068439

§ 371 Date: Dec. 30, 2016

(30) Foreign Application Priority Data
Jul. 3, 2014 (JP) 2014-137487

(51) Int. Cl. D06F 17/08; F16D 28/00; F16D 23/12

(52) U.S. Cl. CPC D06F 17/08; F16D 23/12; F16D 28/00; F16D 2023/123

(57) ABSTRACT

A clutch device for a washing machine may include a second rotor body structured to engage with a first rotor body; a clutch member structured to displace the second rotor body; and a clutch member drive mechanism structured to move the clutch member between a connecting position and a disconnecting position. The clutch member drive mechanism may include a clutch motor structured to rotate in one direction; a crank mechanism comprising a crank member rotationally driven in one direction by the clutch motor and a link member which is swung reciprocatedly interlocked with rotation of the crank member to move the clutch member reciprocatedly; and a guide mechanism structured to guide the clutch member when the clutch member is reciprocated.

### CROSS REFERENCE TO RELATED APPLICATIONS

This is the U.S. national stage of application No. PCT/JP2015/068439, filed on Jun. 26, 2015. Priority under 35 U.S.C. §119(a) and 35 U.S.C. §365(b) is claimed from Japanese Application No. 2014-137487, filed Jul. 3, 2014 the disclosure of which are incorporated herein by reference.

### DESCRIPTION

Technical Field

The present invention relates to a clutch device for a washing machine which is capable of connecting/disconnecting transmission of a rotation driving force from a motor to a washing tub, and relates to a washing machine on which the clutch device for a washing machine is mounted.

Background

A washing machine is described in Patent Literatures 1 and 2 which includes a clutch device (a clutch device for a washing machine) on the way of a driving force transmission path for transmitting a rotation driving force of a motor to a washing tub. The clutch device is structured to transmit a rotation driving force of a motor to a clutch member, which is reciprocatedly swung to perform connection/disconnection (connection and disconnection) of transmission of the rotation driving force to the washing tub. In this case, in a clutch device described in Patent Literature 1, a rotation driving force of a clutch motor is transmitted to a lever gear and the clutch member is reciprocatedly swung by the lever gear. Further, in a clutch device described in Patent Literature 2, a structure is adopted that an output gear is turned by a clutch motor and an eccentric pin provided in an output gear is fitted into an elongated hole formed in a clutch member.

### PATENT LITERATURE

[PTL 1] Japanese Patent Laid-Open No. Hei 11-244578

[PTL 2] Japanese Patent Laid-Open No. 2014-68854

However, in the structure described in Patent Literature 1, a lever gear is directly driven by a clutch motor and thus, rotation of the clutch motor is required to be reversed for connecting/disconnecting transmission of a rotation driving force to a washing tub. Therefore, the motor which can be used is limited. On the other hand, in the clutch device described in Patent Literature 2, a clutch motor is turned only one direction. However, in the clutch device described in Patent Literature 2, in order to reciprocatedly swing a clutch member over a wide angular range, an output gear having a large diameter is required to be used for widening a movable range of an eccentric pin and, when an output gear having a large diameter is used, the output gear and the clutch member and the like may be interfered with each other.

### SUMMARY

In view of the problem described above, at least an embodiment of the present invention provides a clutch device for a washing machine which is capable of connecting and disconnecting transmission of a rotation driving force by rotation in one direction of a clutch motor and easily coping with a requirement for enlarging a moving range of a clutch member, and to provide a washing machine comprising the clutch device for a washing machine.

To solve the above-mentioned problem, at least an embodiment of the present invention provides a clutch device for a washing machine structured to connect and disconnect transmission of a rotation driving force to a washing tub. The clutch device includes a second rotor body engageable with a first rotor body, a clutch member structured to displace the second rotor body, and a clutch member drive mechanism structured to move the clutch member between a connecting position where the second rotor body and the first rotor body are mechanically connected with each other and a disconnecting position where mechanical connection of the second rotor body with the first rotor body is released. The clutch member drive mechanism includes a clutch motor structured to rotate in one direction, a crank mechanism including a crank member rotationally driven in one direction by the clutch motor and a link member which is swung reciprocatedly interlocked with rotation of the crank member to move the clutch member reciprocatedly, and a guide mechanism structured to guide the clutch member when the clutch member is reciprocated. In at least an embodiment of the present invention, “swing reciprocatedly” means an operation of reciprocatedly turning over a predetermined angular range.

In at least an embodiment of the present invention, a crank mechanism is used in the clutch member drive mechanism and, when a clutch motor is rotated in one direction, the crank member is rotated in one direction and the link member is reciprocatedly swung interlocked with the rotation and thus the clutch member is reciprocated between the connecting position and the disconnecting position. Therefore, transmission of a rotation driving force can be connected/disconnected by rotation in one direction of the clutch motor and thus a motor rotating in one direction can be used as the clutch motor. Further, the link member is existed between the crank member to which rotation of the clutch motor is outputted and the clutch member and thus, even when a diameter of the crank member is not enlarged, the clutch member can be reciprocated over a wide angular range. Further, even when the clutch member is required to be reciprocated over a further wide angular range, it is sufficient that the structure of the link member is changed. Therefore, a requirement, for example, that the clutch member is reciprocatedly swung over a wide angular range can be easily coped.

In at least an embodiment of the present invention, it may be structured that the clutch member is swung reciprocatedly interlocked with the link member around an axial line parallel to a swing center axial line of the link member, the guide mechanism is provided with a cam face configured to move the clutch member in a direction that the swing center axial line of the clutch member is extended when the clutch member is swung reciprocatedly, and the clutch member is urged toward the cam face by an urging member. According to this structure, transmission of a rotation driving force can be connected/disconnected with a simple structure by moving the clutch member in a direction that the swing center axial line of the clutch member is extended.

In at least an embodiment of the present invention, it may be structured that the clutch member and the link member are connected with each other through an engaging pin protruded from one of the clutch member and the link member and an elongated hole into which the engaging pin is fitted and which is formed in the other of the clutch member and the link member.

In this case, it is preferable that, when the clutch member is displaced in a direction against an urging force of the urging member, a portion of the engaging pin fitted into the elongated hole is shifted from its tip end side toward its root side and, when the clutch member is displaced in an urging direction by the urging member, the portion of the engaging pin fitted into the elongated hole is shifted from the root side toward the tip end side. When the clutch member is displaced in a direction against an urging force of the urging member, a large load is applied to the engaging pin. However, in this case, when a root portion of the engaging pin is fitted into the elongated hole, the engaging pin 727 is hard to be deformed.

In at least an embodiment of the present invention, it is preferable that the engaging pin is formed in the link member, a main body portion of the link member for holding the engaging pin and the engaging pin are separately provided from each other, and the link member is formed with a plurality of attaching holes for the engaging pin. According to this structure, the engaging pin can be easily provided at a position suitable for a swing range of the clutch member.

In at least an embodiment of the present invention, it is preferable that the crank member is supported by a shaft whose only one end side is supported, and the link member is supported by a shaft whose both end sides are supported. Relative movement in the axial line direction is not occurred between the crank member and the link member and thus a force applied to the crank member in the axial line direction is small. Therefore, even when the crank member is supported by a shaft whose only one end side is supported, inclination or the like is hard to be occurred. On the other hand, the link member and the clutch member are relatively moved to each other in the axial line direction and thus a force is also applied to the link member in the axial line direction. Also in this case, the link member is supported by a shaft whose both ends are supported and thus inclination or the like is hard to be occurred.

In at least an embodiment of the present invention, it is preferable that the clutch member and the link member are connected with each other through an engaging pin protruded from the clutch member and an elongated hole which is formed in the link member and into which the engaging pin is fitted, and a length from a swing center of the link member to the engaging pin and a length from the swing center of the link member to the crank pin are longer than a length from a rotation center of the crank member to the crank pin. According to this structure, a swing center of the link member is separated from the clutch member and the crank member and thus a space for supporting both ends of a shaft which supports the link member can be secured easily.

In at least an embodiment of the present invention, it is preferable that the crank member is structured with a detecting part of a switch for detecting an angular position of the crank member. According to this structure, a structure of the switch can be simplified.

In at least an embodiment of the present invention, it is preferable that the clutch motor, the second rotor body, the clutch member and the crank mechanism are accommodated inside a case. According to this structure, the clutch device for a washing machine is easily mounted on a washing machine.

In this case, it is preferable that the guide mechanism is formed by the case. According to this structure, even when another member is not added, the guide mechanism can be structured.

A washing machine including the clutch device for a washing machine in accordance with at least an embodiment of the present invention includes a washing machine motor, a washing tub, a pulsator which is disposed inside the washing tub, and a driving force transmission mechanism structured to transmit rotation driving force of the washing machine motor to the washing tub and the pulsator. The driving force transmission mechanism includes the clutch device for a washing machine on the way of a driving force transmission path from the washing machine motor to the washing tub. According to this washing machine, an operation for simultaneously rotating the pulsator and the washing tub and an operation for rotating only the pulsator while the washing tub is stopped can be switched by switching a state of the clutch device for a washing machine.

In at least an embodiment of the present invention, a crank mechanism is used in the clutch member drive mechanism and, when a clutch motor is rotated in one direction, the crank member is rotated in one direction and the link member is reciprocatedly swung interlocked with the rotation and thus the clutch member is reciprocated between the connecting position and the disconnecting position. Therefore, transmission of a rotation driving force can be connected/disconnected by rotation in one direction of the clutch motor and thus a motor rotating in one direction can be used as the clutch motor. Further, the link member is existed between the crank member to which rotation of the clutch motor is outputted and the clutch member and thus, even when a diameter of the crank member is not enlarged, the clutch member can be reciprocated over a wide angular range. Further, even when the cutch member is required to be reciprocated over a further wide angular range, it is sufficient that the structure of the link member is changed. Therefore, a requirement, for example, that the clutch member is reciprocatedly swung over a wide angular range can be easily coped.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a longitudinal sectional view showing a schematic structure of a washing machine to which at least an embodiment of the present invention is applied.

FIG. 2 is an exploded perspective view showing a principal part of a driving force transmission mechanism used in a washing machine to which at least an embodiment of the present invention is applied.

FIGS. 3A and 3B are perspective views showing a clutch device viewed from an obliquely upper side to which at least an embodiment of the present invention is applied.

FIGS. 4A and 4B are perspective views showing a clutch device viewed from an obliquely lower side to which at least an embodiment of the present invention is applied.

FIGS. 5A and 5B are perspective views showing a clutch member drive mechanism and the like of a clutch device viewed from an oblique lower side to which at least an embodiment of the present invention is applied.

FIGS. 6A and 6B are bottom views showing a clutch member drive mechanism and the like of a clutch device viewed from a lower side to which at least an embodiment of the present invention is applied.

FIGS. 7A and 7B are side views showing a clutch member drive mechanism and the like of a clutch device viewed from a lateral side to which at least an embodiment of the present invention is applied.

FIGS. 8A and 8B are explanatory views showing a portion where a crank member and the like of a clutch device are disposed to which at least an embodiment of the present invention is applied.

FIGS. 9A and 9B are explanatory views showing a portion where a gear train and the like of a clutch device are disposed which is viewed from a lower side and to which at least an embodiment of the present invention is applied.

FIG. 10 is a bottom view showing a crank mechanism and the like of a clutch device viewed from a lower side in accordance with another embodiment of at least an embodiment of the present invention.

FIG. 11 is a bottom view showing a crank mechanism and the like of a clutch device viewed from a lower side in accordance with further another embodiment of at least an embodiment of the present invention.

### DETAILED DESCRIPTION

At least an embodiment for performing the present invention will be described below with reference to the accompanying drawings. In the following descriptions, a “clutch device for a washing machine” is simply referred to as a “clutch device”.

### (Entire Structure)

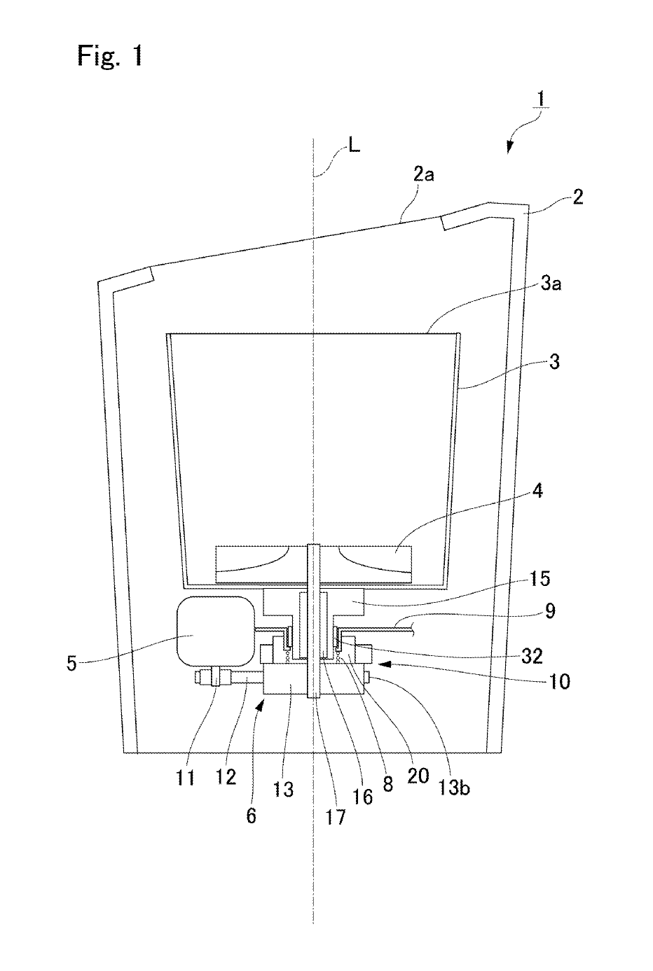

FIG. 1 is a longitudinal sectional view showing a schematic structure of a washing machine to which at least an embodiment of the present invention is applied. As shown in FIG. 1, a washing machine 1 includes a main body frame 2. The main body frame 2 is provided with an opening part 2a through which laundry such as clothes is taken in and out in its upper face. The main body frame 2 is formed in a rectangular tube shape and its under face is opened. A washing tub 3 in a bottomed tube shape is accommodated in an inside of the main body frame 2 so that its opening part 3a faces an upper side. The washing tub 3 is hanged from the main body frame 2 through a buffer member not shown and is set in a rotatable state around its axial line “L”. A pulsator 4 is disposed in a bottom portion on an inner side of the washing tub 3.

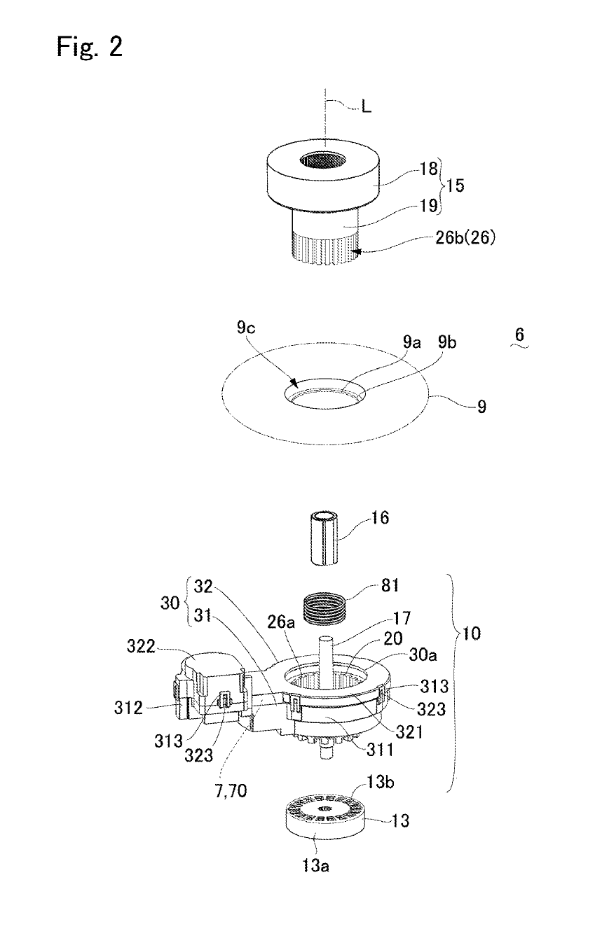

A washing machine motor 5 (motor for a washing machine) is disposed on a lower side of the washing tub 3. A rotation driving force of the washing machine motor 5 is transmitted to the washing tub 3 and the pulsator 4 through a driving force transmission mechanism 6. The driving force transmission mechanism 6 includes a clutch device 10 (clutch device for a washing machine) structured to connect/disconnect transmission of a rotation driving force of the washing machine motor 5 to the washing tub 3 on the way of a driving force transmission path from the washing machine motor 5 to the washing tub 3. Further, a washing tub rotation detection device (not shown) for detecting rotation of the washing tub 3 is disposed on a lower side of the washing tub 3. The clutch device 10 is supported by the main body frame 2 through a support plate 9. In this embodiment, the support plate 9 is formed in a cup shape. However, in FIG. 1 and FIG. 2 described below, only a bottom plate part is shown.

When the washing machine 1 is operated in a state that clothes have been taken into the washing tub 3 through the opening part 2a of the main body frame 2, washing water is supplied inside the washing tub 3 through a water supply pipe not shown. After that, the washing machine motor 5 is driven and, as a result, the pulsator 4 is rotated and washing of clothes inside the washing tub 3 is performed. During washing operation when clothes are washed, the clutch device 10 is set in a disconnecting state that transmission of a rotation driving force of the washing machine motor 5 to the washing tub 3 is disconnected. Therefore, the washing tub 3 is stopped.

Washing operation is finished and, when washing water has been drained from the washing tub 3, dewatering operation for spin-drying clothes is performed. In the dewatering operation, the clutch device 10 is set in a connecting state that a rotation driving force of the washing machine motor 5 is transmitted to the washing tub 3 and, in this state, the washing machine motor 5 is driven. As a result, the pulsator 4 and the washing tub 3 are integrally turned with each other and thus clothes in the washing tub 3 are also turned together with the washing tub 3 and the pulsator 4. Therefore, clothes are spin-dried by centrifugal force.

### (Driving Force Transmission Mechanism)

FIG. 2 is an exploded perspective view showing a principal part of a driving force transmission mechanism 6 used in a washing machine 1 to which at least an embodiment of the present invention is applied. As shown in FIGS. 1 and 2, a driving force transmission mechanism 6 includes a first rotor body 13 to which a rotation driving force of an output shaft 11 of the washing machine motor 5 is transmitted through an endless belt 12, a rotation shaft 17 coaxially attached to the first rotor body 13, a connection member 15 coaxially connected with a lower end portion of the washing tub 3, and a second rotor body 20 connected with the connection member 15. The first rotor body 13 is formed in a disk shape and is coaxially disposed with the washing tub 3 on a lower side of the washing tub 3. A circular outer peripheral face of the first rotor body 13 is used as an attaching face 13a where the endless belt 12 is attached.

As shown in FIG. 2, the first rotor body 13 is provided with a teeth part 13b on its upper end face. The teeth part 13b is formed of a plurality of projections which are extended in a radial direction with equal angular intervals. A lower end portion of the rotation shaft 17 is connected with the first rotor body 13 and its upper end portion is penetrated through a bottom part of the washing tub 3 and is connected with the pulsator 4. Therefore, a rotation driving force of the washing machine motor 5 is transmitted to the pulsator 4 through the endless belt 12, the first rotor body 13 and the rotation shaft 17. In other words, a driving force transmission path comprising the endless belt 12, the first rotor body 13 and the rotation shaft 17 is structured between the washing machine motor 5 and the pulsator 4.

The rotation shaft 17 is disposed on an inner side of a tube-shaped member 16. The tube-shaped member 16 and the rotation shaft 17 are not connected with each other and the tube-shaped member 16 is relatively rotatable with respect to the rotation shaft 17. An outer peripheral side of the tube-shaped member 16 is connected with the connection member 15 and the tube-shaped member 16 and the connection member 15 are integrally turned with each other. The connection member 15 is provided, from an upper side to a lower side in an axial line “L” direction, with a large diameter flange part 18 connected with the washing tub 3 and a small diameter tube part 19 having a smaller diameter than the large diameter flange part 18. The tube-shaped member 16 is inserted on an inner side of the small diameter tube part 19, and the tube-shaped member 16 is connected with the small diameter tube part 19 so as to be turned together with the connection member 15. The second rotor body 20 is coaxially connected with an outer peripheral side of a lower side portion of the small diameter tube part 19.

An inner peripheral face of the second rotor body 20 is formed with a plurality of vertical grooves 26a and an outer peripheral face of the small diameter tube part 19 is formed with a plurality of projections 26b which structure a serration 26 together with the vertical grooves 26a. Therefore, the second rotor body 20 is connected with the connection member 15 in a relatively movable state in the axial line “L” direction and in a rotatable state together with the connection member 15 by the serration 26.

The support plate 9 is a member for supporting the clutch device 10 at a predetermined position to a lower side of the washing tub 3 and is hanged from the main body frame 2 together with the washing tub 3 through a buffer member not shown. The support plate 9 is attached with an upper case 32 for covering an upper side portion of the clutch device 10 from a lower side, and the clutch device 10 is supported by the support plate 9 by fixing the upper case 32 to the support plate 9.

The support plate 9 is provided with a ring-shaped protruded part 9b which is formed with a through hole 9a in its center portion through which the small diameter tube part 19 of the connection member 15 is penetrated in the axial line “L” direction. The ring-shaped protruded part 9b is protruded to a lower side penetrating through an opening part 30a provided in the case 30 and its lower end portion is inserted into an inner side of the second rotor body 20. Further, an urging member 8 comprised of a compression coil spring is inserted between a lower end face of the ring-shaped protruded part 9b and the second rotor body 20. The urging member 8 urges the second rotor body 20 to a lower side (direction toward the first rotor body 13). In addition, a ring-shaped recessed part 9c is formed on an upper face side of the ring-shaped protruded part 9b in the support plate 9. A ring-shaped bearing (not shown) which rotatably supports the washing tub 3 from a lower side through the connection member 15 is disposed inside the recessed part 9c.

### (Structure of Clutch Device 10)

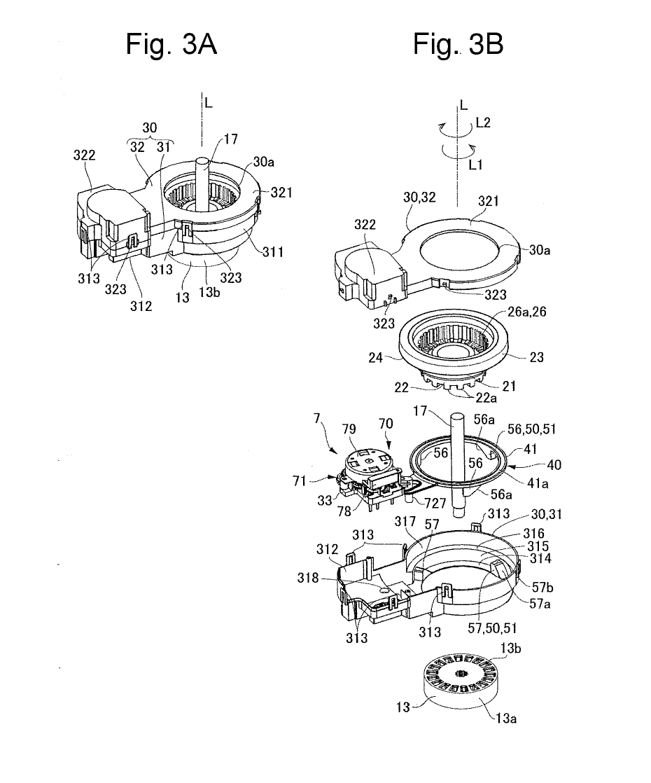

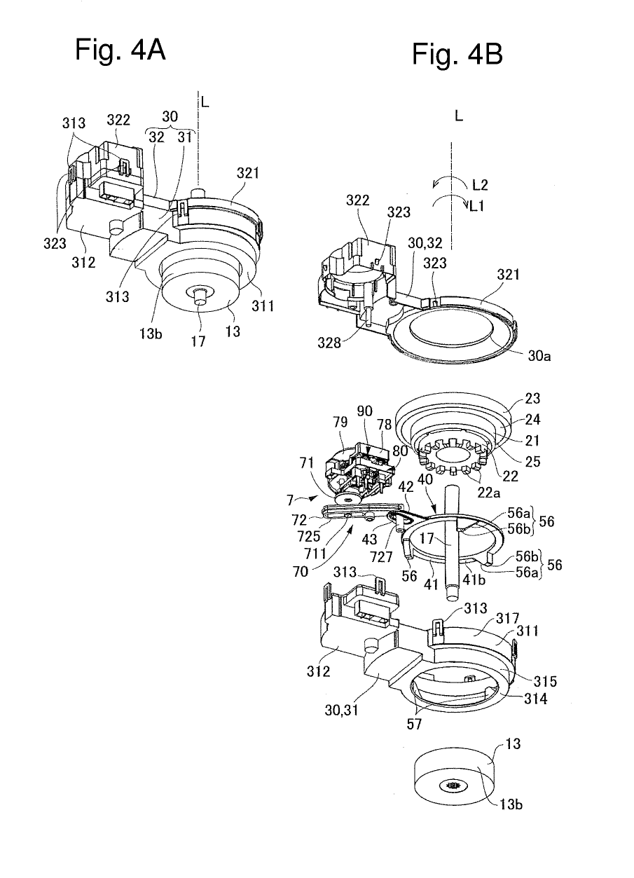

FIGS. 3A and 3B are perspective views showing the clutch device 10 viewed from an obliquely upper side to which at least an embodiment of the present invention is applied. FIG. 3A is a perspective view showing the entire clutch device 10 and FIG. 3B is its exploded perspective view. FIGS. 4A and 4B are perspective views showing the clutch device 10 viewed from an obliquely lower side to which at least an embodiment of the present invention is applied. FIG. 4A is a perspective view showing the entire clutch device 10 and FIG. 4B is its exploded perspective view.

As shown in FIGS. 3A and 3B and FIGS. 4A and 4B, the clutch device 10 includes the second rotor body 20 engageable with the first rotor body 13, a clutch member 40 for displacing the second rotor body, and a clutch member drive mechanism 7 structured to reciprocatedly moves the clutch member 40 between a connecting position where the second rotor body 20 and the first rotor body 13 are mechanically connected with each other and a disconnecting position where a mechanical connection of the second rotor body 20 with the first rotor body 13 is released. Further, the clutch device 10 includes the urging member 8 shown in FIGS. 1 and 2. The urging member 8 urges the clutch member 40 to a lower side through the second rotor body 20. In this embodiment, the clutch member 40 is provided with a circular ring-shaped part 41 and an engaging plate part 42 which is protruded to an outer side in a radial direction from a portion in a circumferential direction of the circular ring-shaped part 41. The clutch member drive mechanism 7 reciprocatedly swings the clutch member 40 around the axial line “L” which passes a center of the circular ring-shaped part 41.

The clutch device 10 includes a case 30 in which the second rotor body 20, the clutch member 40 and the like are accommodated. The case 30 includes a lower case 31 which covers the second rotor body 20, the clutch member 40, the clutch member drive mechanism 7 and the like from a lower side, and an upper case 32 which covers the second rotor body 20, the clutch member 40, the clutch member drive mechanism 7 and the like from an upper side.

The lower case 31 is provided with a first case part 311 formed in a cylindrical tube shape and a second cover part 312 in a rectangular tube shape which is protruded to an outer side in a radial direction from the first case part 311. The upper case 32 is provided with a first cover part 321 in a circular ring shape which is overlapped with the first case part 311 of the lower case 31, and a second cover part 322 in a rectangular tube shape which is protruded to an outer side in a radial direction from the first cover part 321 and is overlapped with the second cover part 312 of the lower case 31. A hook 313 protruded toward an upper side from the lower case 31 is engaged with an engaging projection 323 formed on the side face of the upper case 32 and thereby the lower case 31 and the upper case 32 are connected with each other.

In this state, the second rotor body 20 and the circular ring-shaped part 41 of the clutch member 40 are turnably disposed around the axial line “L” between the first case part 311 and the first cover part 321. A clutch motor 79 and the like used in the clutch member drive mechanism 7 are accommodated between the second cover part 312 and the second cover part 322.

In this embodiment, the first case part 311 of the lower case 31 is provided with a circular ring-shaped bottom plate part 314, a first body part 315 in a cylindrical tube shape which is protruded to an upper side from an outer circumferential edge of the bottom plate part 314, and a second body part 317 in a cylindrical tube shape which is connected with the first body part 315 on an upper side. The second body part 317 has a larger diameter than the first body part 315. Therefore, an inner peripheral face of the first case part 311 is formed with a ring-shaped step part 316 which faces an upper side between the first body part 315 and the second body part 317.

### (Structure of Second Rotor Body 20)

The second rotor body 20 is provided with a first body part 21 in a cylindrical tube shape, a circular ring-shaped flange part 23 enlarged from an upper end part of the first body part 21, and a second body part 22 in a cylindrical tube shape which is protruded to a lower side from the first body part 21. A plurality of vertical grooves 26a structuring the serration 26 is formed on an inner peripheral face of the first body part 21. Since the flange part 23 has a larger diameter than the first body part 21, an outer peripheral face of the second rotor body 20 is formed with a first step part 24 in a ring shape which faces a lower side between the flange part 23 and the first body part 21. The first step part 24 is overlapped with the bottom plate part 314 in a circular ring shape of the lower case 31 on an upper side through the circular ring-shaped part 41 of the clutch member 40. Further, since the second body part 22 has a smaller diameter than the first body part 21, an outer peripheral face of the second rotor body 20 is formed with a second step part 25 in a ring shape which faces a lower side between the second body part 22 and the first body part 21.

A lower end part of the second body part 22 is exposed to a lower side (side where the first rotor body 13 is located) through a hole 314a formed in the bottom plate part 314 of the lower case 31. Further, an under face of the second body part 22 is formed with a teeth part 22a comprised of a plurality of projections which are extended in a radial direction with equal angular intervals. The teeth part 22a is capable of engaging with the teeth part 13b of the first rotor body 13 when the second rotor body 20 is moved to a lower side.

Therefore, the second rotor body 20 is moved to a lower side in an axial line “L” direction and, when the teeth part 22a and the teeth part 13b of the first rotor body 13 are engaged with each other, the second rotor body 20 is integrally rotated with the first rotor body 13 in a coaxial state. As a result, a rotation driving force of the washing machine motor 5 shown in FIG. 1 is transmitted to the washing tub 3 through the endless belt 12, the first rotor body 13, the second rotor body 20 and the connection member 15. In other words, a driving force transmission path comprising the endless belt 12, the first rotor body 13, the second rotor body 20 and the connection member 15 is provided between the washing machine motor 5 and the washing tub 3.

### (Structure of Clutch Member 40 and Guide Mechanism)

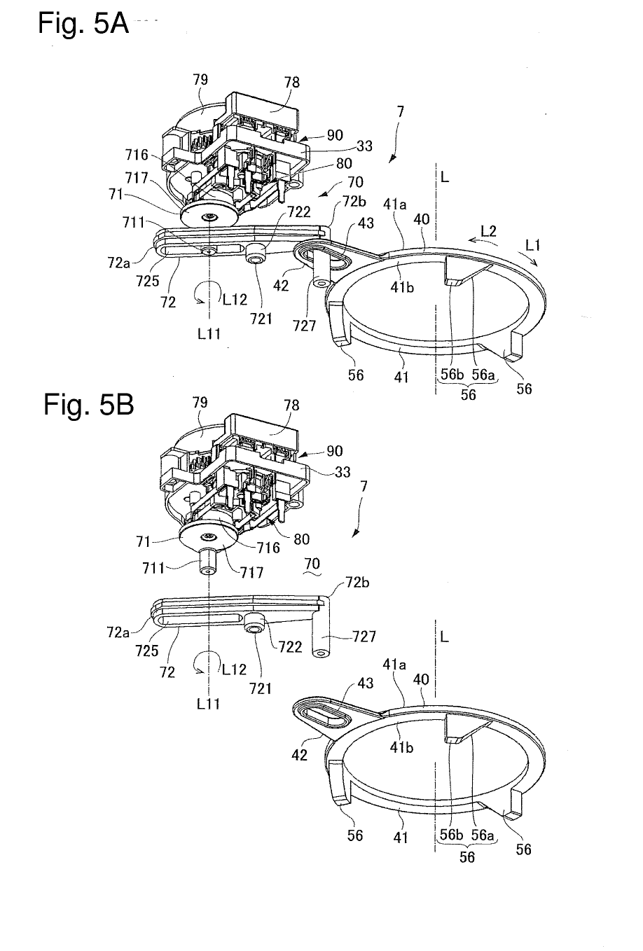

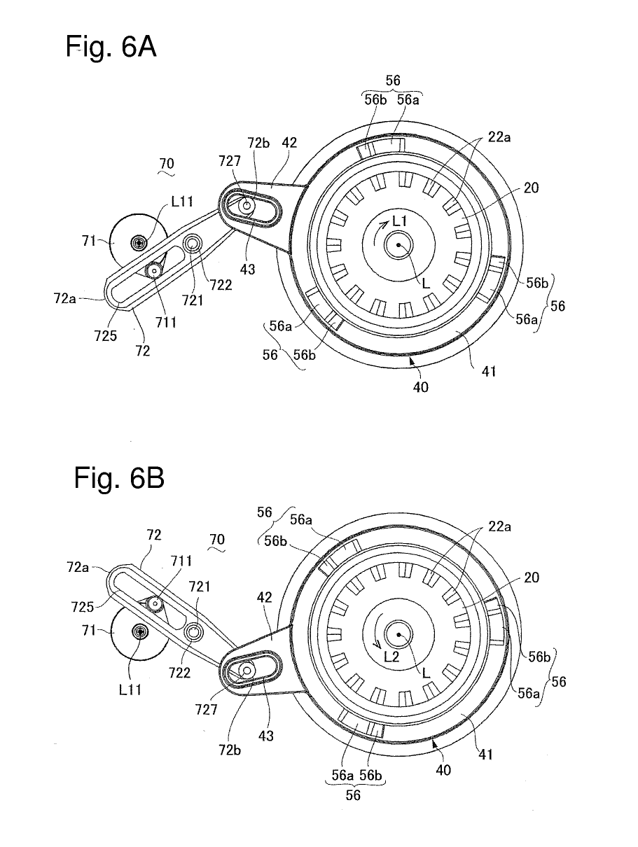

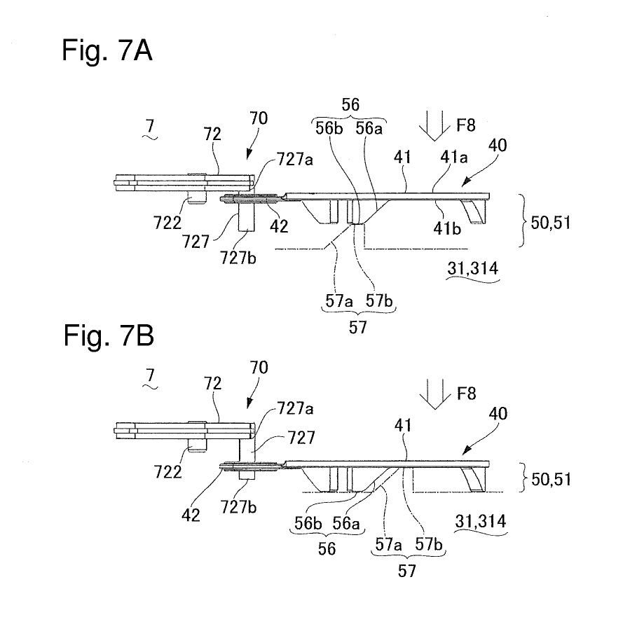

FIGS. 5A and 5B are perspective views showing a clutch member drive mechanism 7 and the like of the clutch device 10 viewed from an oblique lower side to which at least an embodiment of the present invention is applied. FIG. 5A is a perspective view showing the entire clutch member drive mechanism 7 and FIG. 5B is its exploded perspective view. FIGS. 6A and 6B are bottom views showing a clutch member drive mechanism 7 and the like of the clutch device 10 viewed from a lower side to which at least an embodiment of the present invention is applied. FIG. 6A is a bottom view showing the clutch device 10 which is set in a disconnecting state and FIG. 6B is a bottom view showing the clutch device 10 which is set in a connecting state. FIGS. 7A and 7B are side views showing a clutch member drive mechanism 7 and the like of the clutch device 10 viewed from a lateral side to which at least an embodiment of the present invention is applied. FIG. 7A is a side view showing the clutch device 10 which is set in a disconnecting state and FIG. 7B is a side view showing the clutch device 10 which is set in a connecting state.

As shown in FIGS. 3A and 3B, FIGS. 4A and 4B, FIGS. 5A and 5B, FIGS. 6A and 6B and FIGS. 7A and 7B, the clutch member 40 is disposed between the lower case 31 and the second rotor body 20. The clutch member 40 is provided with a circular ring-shaped part 41 and an engaging plate part 42 which is protruded to an outer side in the radial direction from one position in a circumferential direction of the circular ring-shaped part 41. The engaging plate part 42 is formed with an elongated hole 43 which is extended in the radial direction. The circular ring-shaped part 41 has the same size as the ring-shaped bottom plate part 314 of the lower case 31 and the first step part 24 in a ring shape of the second rotor body 20. The first step part 24 of the second rotor body 20 is overlapped with the bottom plate part 314 of the first case part 311 of the lower case 31 through the circular ring-shaped part 41 of the clutch member 40.

An upper face 41a of the circular ring-shaped part 41 is formed to be a flat face without protrusions and recesses, and the first step part 24 of the second rotor body 20 is also formed to be a flat face without protrusions and recesses. Therefore, the upper face 41a of the circular ring-shaped part 41 and the first step part 24 of the second rotor body 20 are overlapped with each other in a face contacted state.

As shown in FIGS. 7A and 7B, a guide mechanism 50 structured to move the clutch member 40 to a connecting position and a disconnecting position described below when the clutch member 40 is turned around the axial line “L” passing through the center of the circular ring-shaped part 41 is structured between the under face 41b of the circular ring-shaped part 41 and the bottom plate part 314 of the lower case 31. In this embodiment, when the clutch member 40 is turned around the axial line “L” passing through the center of the circular ring-shaped part 41, the clutch member 40 is moved in an axial line “L” direction and is moved to a disconnecting position (position shown in FIG. 7A) and a connecting position (position shown in FIG. 7B). Therefore, the guide mechanism 50 structured between the under face 41b of the circular ring-shaped part 41 and the ring-shaped bottom plate part 314 of the lower case 31 is provided with a cam mechanism 51.

As shown in FIGS. 3A and 3B, FIGS. 4A and 4B, FIGS. 5A and 5B, FIGS. 6A and 6B and FIGS. 7A and 7B, the cam mechanism 51 is provided with a first protruded part 56 which is protruded to a lower side from the under face 41b of the circular ring-shaped part 41 of the clutch member 40 so that its slant face 56a faces one side “L1” around the axial line “L”. The first protruded part 56 is provided with a lower end face 56b (sliding part), which is a flat face perpendicular to the axial line “L”, at a portion adjacent to the slant face 56a on the other side “L2” around the axial line “L”. In this embodiment, the first protruded part 56 is formed at three positions in a circumferential direction. A portion of the under face 41b where the first protruded part 56 is not formed is formed in a flat face perpendicular to the axial line “L”.

The cam mechanism 51 is provided with a second protruded part 57 which is protruded to an upper side from an upper face of the bottom plate part 314 of the lower case 31 so that its slant face 57a (first cam face) faces the other side “L2” around the axial line. The second protruded part 57 is provided with an upper end face 57b which is a flat face perpendicular to the axial line “L” (second cam face) at a portion adjacent to the slant face 57a on one side “L1” around the axial line “L”. In this embodiment, the second protruded part 57 is formed at three positions in the circumferential direction. A face of the upper face of the bottom plate part 314 where the second protruded part 57 is not formed is formed to be a flat face (third cam face) perpendicular to the axial line “L”.

### (Operation of Clutch Member Drive Mechanism 7 and Clutch Device 10)

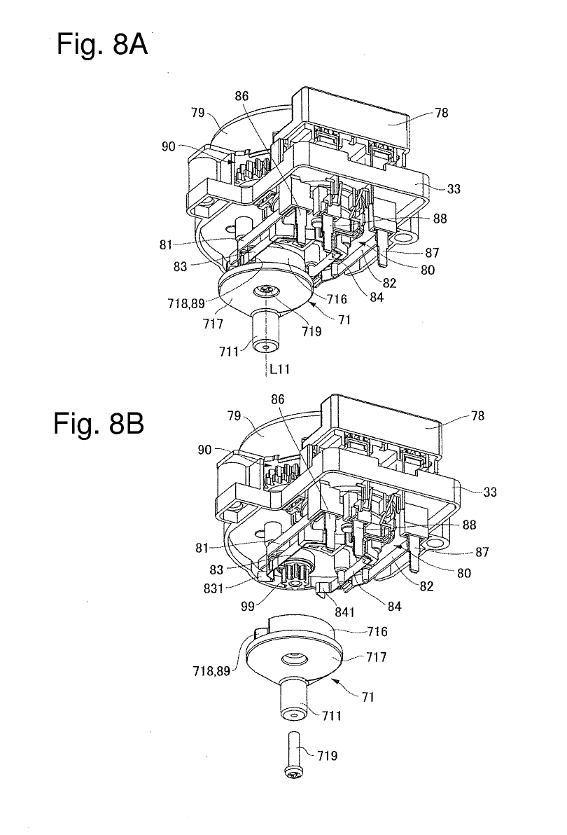

FIGS. 8A and 8B are explanatory views showing a portion where a crank member 71 and the like of the clutch device 10 are disposed to which at least an embodiment of the present invention is applied. FIG. 8A is a perspective view showing a portion where a crank member 71 and the like are disposed which is viewed from an obliquely lower side, and FIG. 8B is a perspective view showing a state that a crank member 71 is detached which is viewed from an obliquely lower side.

As shown in FIGS. 5A and 5B, the clutch member drive mechanism 7 includes a clutch motor 79 as a drive source. The clutch motor 79 is a synchronous motor and is rotated in only one direction. Further, the clutch member drive mechanism 7 has a crank mechanism 70. The crank mechanism 70 includes a crank member 71 which is rotationally driven by the clutch motor 79 in one direction and a link member 72 which is swung reciprocatedly interlocked with rotation of the crank member 71, and thereby the clutch member 40 is swung reciprocatedly. Further, the clutch member drive mechanism 7 includes a gear train 90 which transmits rotation of the clutch motor 79 to the crank member 71.

The crank member 71 is a rotation member driven by the clutch motor 79 through the gear train 90 in one direction “L12” around an axial line “L11” which is parallel to the axial line “L”. The crank member 71 includes a crank pin 711 which is an eccentric pin protruded in parallel with the axial line “L11” at a position separated from the axial line “L11”.

More specifically, as shown in FIGS. 8A and 8B, the crank member 71 includes a cylindrical tube part 716 connected with the output gear 99 and a circular plate part 717 which is enlarged from a lower end part of the cylindrical tube part 716. The crank pin 711 is formed on the circular plate part 717. The cylindrical tube part 716 is formed with an engagement hole (not shown) into which an output gear 99 is fitted and is connected with the output gear 99 by a screw 719. In this embodiment, an outer peripheral face of the cylindrical tube part 716 is formed with a recessed part 718 at one position in a circumferential direction. The recessed part 718 structures a detecting part 89 of a switch 80 described below for detecting an angular position of the crank member 71.

In FIGS. 5A and 5B, the link member 72 is an arm member which is extended from the crank pin 711 to an overlapped position with an elongated hole 43 of the clutch member 40. A tube part 722 formed with a shaft hole 721 is formed at a substantially middle position in a longitudinal direction of the link member 72. A support shaft 328 formed in the upper case 32 (see FIG. 4B) is fitted to the shaft hole 721. The support shaft 328 is extended in parallel with the axial line “L” and its lower end part is fitted into a hole 318 (see FIG. 3B) formed in the lower case 31. Therefore, the link member 72 is supported by the support shaft 328 whose both ends are supported by the case 30.

One end side 72a of the link member 72 is formed with an elongated hole 725 which is extended from the one end side 72a toward the tube part 722 and the crank pin 711 is fitted into the elongated hole 725. Further, the other end side 72b of the link member 72 is formed with an engaging pin 727 protruded to a lower side, and the engaging pin 727 is fitted to the elongated hole 43 of the clutch member 40.

In the clutch device 10 structured as described above, when the crank member 71 makes one rotation around the axial line “L11”, the link member 72 is reciprocatedly swung with the support shaft 328 as a center and, as a result, the clutch member 40 is reciprocatedly swung around the axial line “L”.

Therefore, the clutch member 40 is, as shown in FIG. 6A, turned to one side “L1” around the axial line “L”, the first protruded part 56 of the clutch member 40 runs on the slant face 57a of the second protruded part 57 formed on the bottom plate part 314 of the lower case 31 as shown in FIG. 7A and then the first protruded part 56 is overlapped with the upper end face 57b of the second protruded part 57. As a result, the clutch member 40 pushes up the second rotor body 20 to an upper side against an urging force “F8” of the urging member 8 shown in FIG. 1. Therefore, engagement of the teeth part 22a of the second rotor body 20 with the teeth part 13b of the first rotor body 13 is released and thus a mechanical connection of the second rotor body 20 with the first rotor body 13 is released. Accordingly, even when the first rotor body 13 is rotated, the second rotor body 20 does not rotate and thus the pulsator 4 shown in FIG. 1 is rotated but the washing tub 3 is not rotated.

When the clutch member 40 is turned to the other side “L2” around the axial line “L” from this state as shown in FIG. 6B, the first protruded part 56 slides down the slant face 57a of the second protruded part 57 formed on the bottom plate part 314 of the lower case 31. As a result, the clutch member 40 and the second rotor body 20 are moved to a lower side by the urging force “F8” of the urging member 8 shown in FIG. 1. Therefore, the teeth part 22a and the teeth part 13b of the first rotor body 13 are engaged with each other and thus the second rotor body 20 and the first rotor body 13 are mechanically connected with each other. Accordingly, when the first rotor body 13 is rotated, the second rotor body 20 is also rotated and both of the pulsator 4 and the washing tub 3 shown in FIG. 1 are rotated.

In the clutch operation described above, when the clutch member 40 is displaced in the direction against the urging force “F8” of the urging member 8 as shown in FIG. 6A, a portion of the engaging pin 727 fitted into the elongated hole 43 is shifted from its tip end side 727b toward its root side 727a. On the other hand, when the clutch member 40 is displaced in the urging direction by the urging member 8 as shown in FIG. 6B, the portion of the engaging pin 727 fitted into the elongated hole 43 is shifted from the root side 727a toward the tip end side 727b.

(Structure of Gear Train 90 and Switch 80 and the like)

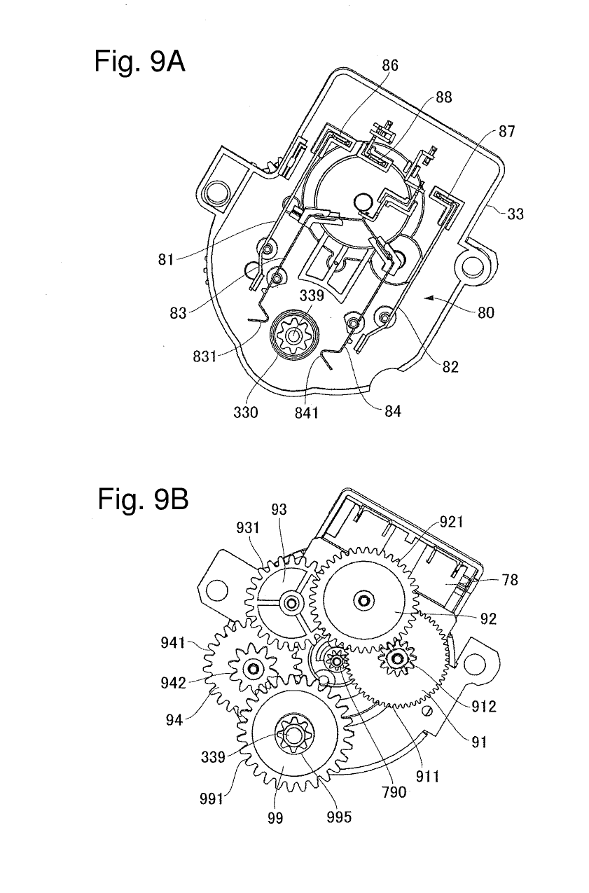

FIGS. 9A and 9B are explanatory views showing a portion where a gear train 90 and the like of the clutch device 10 are disposed which is viewed from a lower side and to which at least an embodiment of the present invention is applied. FIG. 9A is an explanatory view showing a switch 80 disposed in a portion overlapped with a gear train 90, and FIG. 9B is an explanatory view showing a gear train 90.

As shown in FIGS. 3A and 3B and FIGS. 4A and 4B, an intermediate plate 33 is disposed between the second cover part 312 of the lower case 31 and the second cover part 322 of the upper case 32. The clutch motor 79 and the like are disposed between the intermediate plate 33 and the second cover part 322 of the upper case 32.

Further, as shown in FIGS. 8A and 8B and FIG. 9A, a switch 80 comprised of switch pieces 81, 82, 83 and 84 made of metal plates extended in a strip shape is structured on a lower side of the intermediate plate 33 (between the intermediate plate 33 and the second cover part 312 of the lower case 31). Further, terminals 86, 87 and 88 are provided on base end sides of the switch pieces 81, 82, 83 and 84.

In the switch pieces 81, 82, 83 and 84, the switch pieces 81 and 82 are stationary and the switch pieces 83 and 84 are structured so that abutting parts 831 and 841 formed to be bent on their tip end sides are resiliently abutted with an outer peripheral face of the cylindrical tube part 716 of the crank member 71. Therefore, on the outer peripheral face of the cylindrical tube part 716 of the crank member 71, during the abutting parts 831 and 841 are abutted with a portion except the recessed part 718, the switch piece 81 and the switch piece 83 are contacted with each other and the switch piece 82 and the switch piece 84 are contacted with each other. Next, when the crank member 71 is turned and the abutting part 831 is dropped into the recessed part 718, the switch piece 81 and the switch piece 83 are separated from each other. Further, when the crank member 71 is turned and the abutting part 841 is dropped into the recessed part 718, the switch piece 82 and the switch piece 84 are separated from each other. Therefore, an angular position of the crank member 71 is detected by the switch 80. In this case, the recessed part 718 is utilized as a detecting part 89 of the switch 80. In this embodiment, control for the clutch motor 79 and the like are performed based on a detected result of the switch 80.

As shown in FIGS. 8A and 8B and FIG. 9B, the clutch motor 79 is disposed on an upper side of the intermediate plate 33 (between the intermediate plate 33 and the second cover part 322 of the upper case 32). The gear train 90 is disposed between a bobbin 78 made of resin around which a coil (not shown) is wound in the clutch motor 79 and the intermediate plate 33. In this embodiment, the gear train 90 includes a first gear 91, a second gear 92, a third gear 93 and a fourth gear 94, and an output gear 99 is engaged with a small diameter gear 942 of the fourth gear 94. The gear train 90 is structured as a reduction gear train. More specifically, the first gear 91 is provided with a large diameter gear 911 engaged with a motor pinion 790 and a small diameter gear 912 coaxially formed with the large diameter gear 911. The second gear 92 is provided with a large diameter gear 921 engaged with the small diameter gear 912 of the first gear 91 and a small diameter gear (not shown) coaxially formed with a large diameter gear 921. The third gear 93 is provided with a large diameter gear 931 engaged with the small diameter gear of the second gear 92 and a small diameter gear (not shown) coaxially formed with the large diameter gear 931. The fourth gear 94 is provided with a large diameter gear 941 engaged with the small diameter gear of the third gear 93 and a small diameter gear 942 coaxially formed with the large diameter gear 941. The output gear 99 is provided with a gear 991 engaged with the small diameter gear 942 of the fourth gear 94 and a protruded part 995 coaxially formed with the gear 991. The protruded part 995 is protruded to a lower side through a hole 330 formed in the intermediate plate 33 and is connected with the crank member 71.

In this embodiment, the first gear 91, the second gear 92, the third gear 93 and the fourth gear 94 are supported by support shafts (not shown) both ends of which are supported by the bobbin 78 and the intermediate plate 33. On the other hand, the output gear 99 is supported by a support shaft 339 one end of which is supported by the bobbin 78. Therefore, the crank member 71 is set in a state supported by the support shaft 339 whose one end is supported by the bobbin 78.

### Principal Effects in this Embodiment

As described above, in the clutch device 10 in this embodiment, the crank mechanism 70 is used in the clutch member drive mechanism 7 and, when the clutch motor 79 is rotated in one direction, the crank member 71 is rotated in one direction and the link member 72 is reciprocatedly swung interlocked with the rotation and thus the clutch member 40 is reciprocated between the connecting position and the disconnecting position. Therefore, transmission of a rotation driving force can be connected/disconnected by rotation in one direction of the clutch motor 79 and thus a motor rotating in one direction can be used as the clutch motor 79. Further, the link member 72 is existed between the crank member 71 to which rotation of the clutch motor 79 is outputted and the clutch member 40 and thus, even when a diameter of the crank member 71 is not enlarged, the clutch member 40 can be reciprocated over a wide angular range. Further, even when the clutch member 40 is required to be reciprocated over a further wide angular range, it is sufficient that the structure of the link member 72 is changed. Therefore, a requirement, for example, that the clutch member 40 is reciprocatedly swung over a wide angular range can be easily coped.

The clutch member 40 is reciprocatedly swung around the axial line “L11” parallel to a swing center axial line of the link member 72 interlocked with the link member 72, and the guide mechanism 50 is provided with a cam face (second protruded part 57) structured to move the clutch member 40 in a direction extended in the swing center axial line (axial line “L”) of the clutch member 40 when the clutch member 40 is reciprocatedly swung. Therefore, transmission of a rotation driving force can be connected/disconnected by moving the clutch member 40 in a direction extended in the axial line “L” of the clutch member 40 with a simple structure. Further, the guide mechanism 50 (cam mechanism 51) for the clutch member 40 is formed by utilizing the case 30 and thus, even when another member is not added, the guide mechanism 50 can be structured.

When the clutch member 40 is displaced in a direction against an urging force of the urging member 8, a portion of the engaging pin 727 of the link member 72 which is fitted to the elongated hole 43 of the clutch member 40 is shifted toward its root side 727a from the tip end side 727b. Therefore, when the clutch member 40 is displaced in a direction against an urging force of the urging member 8, a large load is applied to the engaging pin 727 but the engaging pin 727 is hard to be deformed.

Further, the crank member 71 is supported by the support shaft 339 (see FIG. 9B) whose only one end side is supported, and the link member 72 is supported by the support shaft 328 whose both end sides are supported. Relative movement in the axial line direction is not occurred between the crank member 71 and the link member 72 and thus a force applied to the crank member 71 in the axial line direction is small. Therefore, even when the crank member 71 is supported by the support shaft 339 whose only one end side is supported, inclination or the like is hard to be occurred. On the other hand, the link member 72 and the clutch member 40 are relatively moved to each other in the axial line direction and thus a force is also applied to the link member 72 in the axial line direction. Also in this case, the link member 72 is supported by the support shaft 328 both ends of which are supported and thus inclination or the like is hard to be occurred.

A length from a swing center (support shaft 328 and shaft hole 721) of the link member 72 to the engaging pin 727 and a length from the swing center of the link member 72 to the crank pin 711 are longer than a length from the rotation center (support shaft 339) of the crank member 71 to the crank pin 711. Therefore, the swing center of the link member 72 is separated from the clutch member 40 and the crank member 71 and thus a space for supporting both ends of the support shaft 328 which supports the link member 72 can be secured easily.

The crank member 71 is structured with the detecting part 89 (recessed part 718) of the switch 80 for detecting an angular position of the crank member 71 and thus the structure of the switch 80 can be simplified.

The clutch motor 79, the second rotor body 20, the clutch member 40, the crank mechanism 70 and the like are accommodated inside the case 30 and thus the clutch device 10 is easily mounted on the washing machine 1.

### Another Embodiment

FIG. 11 is a bottom view showing a crank mechanism 70 and the like of a clutch device 10 viewed from a lower side in accordance with another embodiment of the present invention. A basic structure in this embodiment is similar to the embodiment described with reference to FIGS. 1 through 9B and thus the same reference signs are used in common portions and their descriptions are omitted.

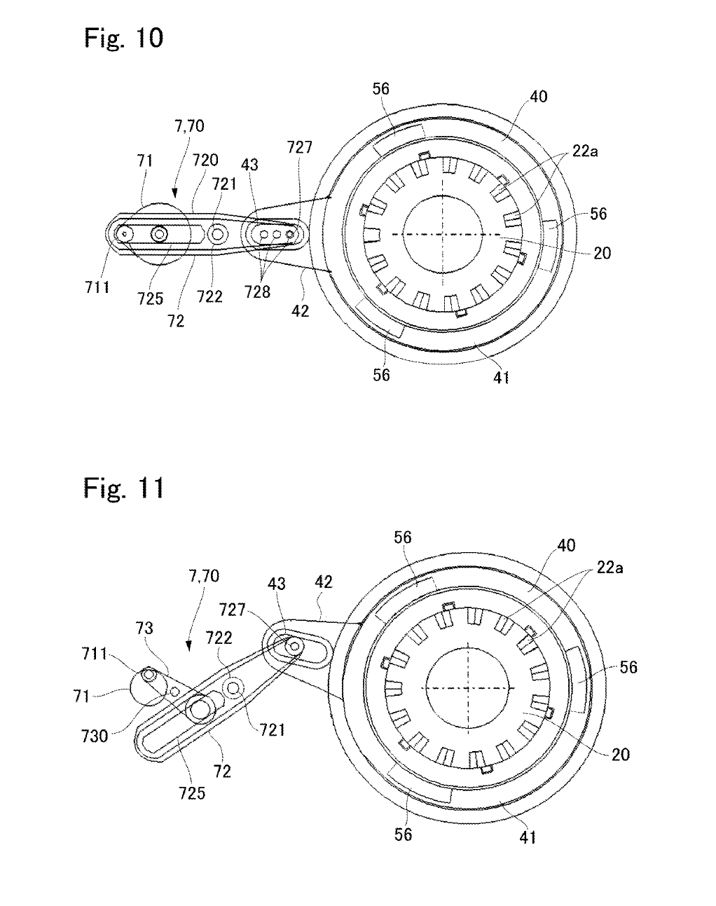

In the embodiment described above, the position of the engaging pin 727 is fixed in the link member 72. However, in this embodiment, as shown in FIG. 10, a main body portion 720 for holding an engaging pin 727 and the engaging pin 727 are separately structured from each other in the link member 72 and the main body portion 720 is formed with a plurality of attaching holes 728 for the engaging pin 727. According to this structure, the engaging pin 727 can be attached to one of the plurality of the attaching holes 728 which is provided at a suitable position for a region where the clutch member 40 is reciprocatedly swung. Therefore, even when the entire link member 72 is not exchanged, the link member 72 can be provided at a position suitable for a swing range of the clutch member 40.

### Further Another Embodiment

FIG. 11 is a bottom view showing a crank mechanism 70 and the like of a clutch device 10 viewed from a lower side in accordance with further another embodiment of the present invention. A basic structure in this embodiment is similar to the embodiment described with reference to FIGS. 1 through 9B and thus the same reference signs are used in common portions and their descriptions are omitted.

In the embodiment described above, one link member 72 is used in the crank mechanism 70 but a plurality of link members may be used. For example, as shown in FIG. 11, two link members 72 and 73 are used. In the link members 72 and 73, the link member 73 is provided with a swing support point 730 at a middle position in its length direction, and a crank pin 711 of the crank member 71 is rotatably fitted to a hole 735 formed at one end of the link member 73. Further, an engaging pin 737 is provided at the other end of the link member 73, and the engaging pin 737 is fitted into an elongated hole 725 of the link member 72. Also in this structure, when the crank member 71 is rotated in one direction, the link members 72 and 73 are reciprocatedly swung and thus the clutch member 40 can be swung reciprocatedly.

### Other Embodiments

In the embodiment described above, for example, the engaging pin 727 provided in the link member 72 is fitted into the elongated hole 43 of the clutch member 40. However, it may be structured that an engaging pin provided in the clutch member 40 is fitted into an elongated hole provided in the link member 72.

In the embodiment described above, the clutch member drive mechanism 7 is structured so as to move the clutch member 40 to swing reciprocatedly. However, it may be structured that the clutch member drive mechanism 7 makes the clutch member 40 reciprocate linearly.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A clutch device for a washing machine structured to connect and disconnect transmission of a rotation driving force to a washing tub, the clutch device comprising:
a second rotor body structured to engage with a first rotor body;
a clutch member structured to displace the second rotor body; and
a clutch member drive mechanism structured to move the clutch member between a connecting position where the second rotor body and the first rotor body are mechanically connected with each other and a disconnecting position where mechanical connection of the second rotor body with the first rotor body is released;
wherein the clutch member drive mechanism comprises:
a clutch motor structured to rotate in one direction;
a crank mechanism comprising a crank member rotationally driven in one direction by the clutch motor and a link member which is swung reciprocatedly interlocked with rotation of the crank member to move the clutch member reciprocatedly; and
a guide mechanism structured to guide the clutch member when the clutch member is reciprocated.

2. The clutch device for a washing machine according to claim 1, wherein
the clutch member is swung reciprocatedly interlocked with the link member around an axial line parallel to a swing center axial line of the link member,
the guide mechanism comprises a cam face configured to move the clutch member in a direction that a swing center axial line of the clutch member is extended when the clutch member is swung reciprocatedly, and
the clutch member is urged toward the cam face by an urging member.

3. The clutch device for a washing machine according to claim 2, wherein the clutch member and the link member are connected with each other through an engaging pin protruded from one of the clutch member and the link member and an elongated hole into which the engaging pin is fitted and which is formed in the other of the clutch member and the link member.

4. The clutch device for a washing machine according to claim 3, wherein
when the clutch member is displaced in a direction against an urging force of the urging member, a portion of the engaging pin fitted into the elongated hole is relatively shifted from its tip end side toward its root side, and
when the clutch member is displaced in an urging direction by the urging member, the portion of the engaging pin fitted into the elongated hole is relatively a shifted from the root side toward the tip end side.

5. The clutch device for a washing machine according to claim 3, wherein
the engaging pin is formed in the link member,
a main body portion of the link member for holding the engaging pin and the engaging pin are separately provided from each other, and
the link member is formed with a plurality of attaching holes for the engaging pin.

6. The clutch device for a washing machine according to claim 3, wherein
the crank member is supported by a first shaft, only one end side of the first shaft being supported, and
the link member is supported by a second shaft, both end sides of the second shaft supported.

7. The clutch device for a washing machine according to claim 6, wherein
the clutch member and the link member are connected with each other through an engaging pin protruded from the clutch member and an elongated hole which is formed in the link member and into which the engaging pin is fitted, and
a length from a swing center of the link member to the engaging pin and a length from the swing center of the link member to a clunk pin provided in the crank member are longer than a length from a rotation center of the crank member to the crank pin.

8. The clutch device for a washing machine according to claim 1, wherein the crank member is structured with a detecting part of a switch for detecting an angular position of the crank member.

9. The clutch device for a washing machine according to claim 1, wherein the clutch motor, the second rotor body, the clutch member and the crank mechanism are accommodated inside a case.

10. The clutch device for a washing machine according to claim 9, wherein the guide mechanism is formed by the case.

11. A washing machine comprising:
a washing machine motor;
a washing tub;
a pulsator which is disposed inside the washing tub; and
a driving force transmission mechanism structured to transmit rotation driving force of the washing machine motor to the washing tub and the pulsator;
wherein the driving force transmission mechanism comprises the clutch device structured to connect and disconnect transmission of the rotation driving force to the washing tub on a way of a driving force transmission path from the washing machine motor to the washing tub wherein the clutch device comprises:
a second rotor body structured to engage with a first rotor body;
a clutch member structured to displace the second rotor body; and
a clutch member drive mechanism structured to move the clutch member between a connecting position where the second rotor body and the first rotor body are mechanically connected with each other and a disconnecting position where mechanical connection of the second rotor body with the first rotor body is released;
wherein the clutch member drive mechanism comprises:
a clutch motor structured to rotate in one direction;
a crank mechanism comprising a crank member rotationally driven in one direction by the clutch motor and a link member which is swung reciprocatedly interlocked with rotation of the crank member to move the clutch member reciprocatedly; and
a guide mechanism structured to guide the clutch member when the clutch member is reciprocated; and
wherein the pulsator is connected with the first rotor body and the washing tub is connected with second rotor body.

12. The clutch device for a washing machine according to claim 3, wherein
the clutch member and the link member are connected with each other through an engaging pin protruded from the link member and an elongated hole which is formed in the clutch member and into which the engaging pin is fitted, and
a length from a swing center of the link member to the engaging pin and a length from the swing center of the link member to a crank pin provided in the crank member are longer than a length from a rotation center of the crank member to the crank pin.

13. The clutch device for a washing machine according to claim 4, wherein
the engaging pin is formed in the link member,
a main body portion of the link member for holding the engaging pin and the engaging pin are separately provided from each other, and
the link member is formed with a plurality of attaching holes for the engaging pin.

14. The clutch device for a washing machine according to claim 6, wherein
when the clutch member is displaced in a direction against an urging force of the urging member, a portion of the engaging pin fitted into the elongated hole is relatively shifted from its tip end side toward its root side, and
when the clutch member is displaced in an urging direction by the urging member, the portion of the engaging pin fitted into the elongated hole is relatively shifted from the root side toward the tip end side.

15. The washing machine according to claim 11, wherein
the clutch member is swung reciprocatedly interlocked with the link member around an axial line parallel to a swing center axial line of the link member,
the guide mechanism is provided with a cam face configured to move the clutch member in a direction that a swing center axial line of the clutch member is extended when the clutch member is swung reciprocatedly, and
the clutch member is urged toward the cam face by an urging member.

16. The washing machine according to claim 15, wherein the clutch member and the link member are connected with each other through an engaging pin protruded from one of the clutch member and the link member and an elongated hole into which the engaging pin is fitted and which is formed in the other of the clutch member and the link member.

17. The washing machine according to claim 16, wherein
when the clutch member is displaced in a direction against an urging force of the urging member, a portion of the engaging pin fitted into the elongated hole is relatively shifted from its tip end side toward its root side, and
when the clutch member is displaced in an urging direction by the urging member, the portion of the engaging pin fitted into the elongated hole is relatively shifted from the root side toward the tip end side.

18. The washing machine according to claim 16, wherein
the engaging pin is formed in the link member,
a main body portion of the link member for holding the engaging pin and the engaging pin are separately provided from each other, and
the link member is formed with a plurality of attaching holes for the engaging pin.

19. The washing machine according to claim 16, wherein
the clutch member and the link member are connected with each other through an engaging pin protruded from the link member and an elongated hole which is formed in the clutch member and into which the engaging pin is fitted, and
a length from a swing center of the link member to the engaging pin and a length from the swing center of the link member to a crank pin provided in the crank member are longer than a length from a rotation center of the crank member to the crank pin.

20. The washing machine according to claim 11, wherein the clutch motor, the second rotor body, the clutch member and the crank mechanism are accommodated inside a case.
